(19) United States
(12) Patent Application Publication
(10) Pub. No.: US 2007/0283237 A1
(43) Pub. Date: Dec. 6, 2007

(54) Systems and Methods for Multimedia Content Distribution and Playback

(76) Inventors: Ke-Chiang Chu, Saratoga, CA (US); James P. Tann, Monterey, CA (US); Johnathan P. Tann, San Francisco, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/421,971

(22) Filed: Jun. 2, 2006

(51) Int. Cl. G06F 17/00

(52) U.S. Cl. 715/500.1

(57) ABSTRACT

The present invention relates generally to multimedia playback devices, and more particularly to systems and methods for multimedia content distribution and playback. In accordance with one preferred embodiment, a method for distributing multimedia content to a playback system includes the steps of converting the multimedia content into an intermediate format, loading the converted multimedia content into the playback system, and converting the multimedia content from the intermediate format to a format supported by the playback system, wherein the intermediate format and the format supported by the playback system are different.

### FIELD OF THE INVENTION

The present invention relates generally to multimedia playback systems, and more particularly to systems and methods for multimedia content distribution and playback.

### BACKGROUND OF THE INVENTION

The ability to play multimedia content (e.g., video, image, and audio files) has become a common feature in personal handheld computing devices and/or wireless devices, such as cellular phones, portable multimedia players, and personal digital assistants (“PDA's”), because the state of the art allows the required hardware (e.g., the display screen and video processor) to be made small enough and cheap enough. The multimedia files are typically loaded onto the computing devices from a storage medium, such as a portable memory device (e.g., flash memory card, DVD, CD, Read Only Memory card, microdrive or minidisc) inserted into the computing device or a file server communicatively connected to the device, or a broadcast medium, such as a television broadcast. FIGS. 1a and 1b illustrate the operation of a traditional digital audio/video content distribution 10 and playback 50 system typically used for such devices. The content distribution system 10 is shown in FIG. 1a. Video files 12 are coded with an audio encoder known in the art 14, such as an MP3 encoder, and a video encoder known in the art 16, such as the H.264 encoder, into audio and video coded bit streams, respectively. The audio and video coded bit streams are then packed 24 into packed bit streams, such as QuickTime™ bit streams or Windows Media Player supported bit streams and loaded onto storage media 30, such as a portable memory device (e.g., flash memory card) or file server, or transmitted via a transmission media, such as a wireless network 30 or a broadcast network (e.g., UHF, VHF, etc.), to target devices, such as a smart phone for playback.

The playback 50 system is shown in FIG. 1b. The target device 50 receives the packed bit stream either from the storage media 30 or through the transmission media 30. The packed bit streams are unpacked 52 and decoded by the corresponding audio 56 and video 54 decoders into audio and video decoded bit streams, respectively. Then the decoded bit streams are sent to audio and video players 58 for playback.

Different target devices typically have different formatting requirements, e.g., different screen sizes and color depth as well as different codec systems. The following table illustrates different playback screen sizes and color depths supported by the mobile phones with different Symbian Operating Systems, as an example.

| Model | Screen Size (pixels) | Colors |
|---|---|---|
| Nokia 6600 | 176 × 208 | 65536 |
| (Symbian Series 60) | | |
| Nokia 9300 | 640 × 200 | 65536 |
| (Symbian Series 80) | | |
| Sony Ericsson 910 | 208 × 320 | 262000 |
| (Symbian UIQ) | | |

Because of the different formatting requirements, a packed bit stream suitable for playback in one type of device, e.g., the Nokia 6600, may not be suitable for another type of device, e.g., the Nokia 9300. The typical approach to address this problem is to have the content distribution system 10 provide a packed bit stream for each potential type of target device. Thus, for the above three (3) Symbian phones, for example, the content distribution system 10 would need to create three (3) packed bit streams—one (1) bit stream for Nokia 6600, one (1) bit stream for Nokia 9300, and one (1) bit stream for Sony Ericsson 910.

A significant drawback to this approach is that there are a large number of different types of target devices and playback environments, each with different formatting requirement. Thus, for each video file to be distributed, a large number of packed bit streams would have to be encoded and stored, each corresponding to a particular type of device or formatting requirements. This may require a larger amount storage space and/or network bandwidth, which is particularly undesirable when using flash memory devices and wireless networks for content distribution, where storage space and bandwidth are more expensive.

Accordingly, improved systems and methods for multimedia content distribution and playback is desirable.

### SUMMARY OF THE INVENTION

The present invention relates generally to multimedia playback devices, and more particularly to systems and methods for multimedia content distribution and playback. In accordance with one preferred embodiment, a method for distributing multimedia content to a playback system includes the steps of converting the multimedia content into an intermediate format, loading the converted multimedia content into the playback system, and converting the multimedia content from the intermediate format to a format supported by the playback system, wherein the intermediate format and the format supported by the playback system are different.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

In order to better appreciate how the above-recited and other advantages and objects of the present inventions are obtained, a more particular description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1a is a diagram of a system for encoding and packing multimedia content known in the art.

FIG. 1b is a diagram of a system for unpacking and decoding multimedia content known in the art.

FIG. 2 is a process in accordance with a preferred embodiment of the present invention.

FIG. 3 is a diagram of a system for encoding and packing multimedia content in accordance with a preferred embodiment of the present invention.

FIG. 4 is a diagram of a system for unpacking and decoding multimedia content in accordance with a preferred embodiment of the present invention.

FIG. 5 is a diagram of a system for selecting an intermediate frame size in accordance with a preferred embodiment of the present invention.

FIG. 6 is a diagram of a system for converting an intermediate frame size to a target frame size in accordance with a preferred embodiment of the present invention.

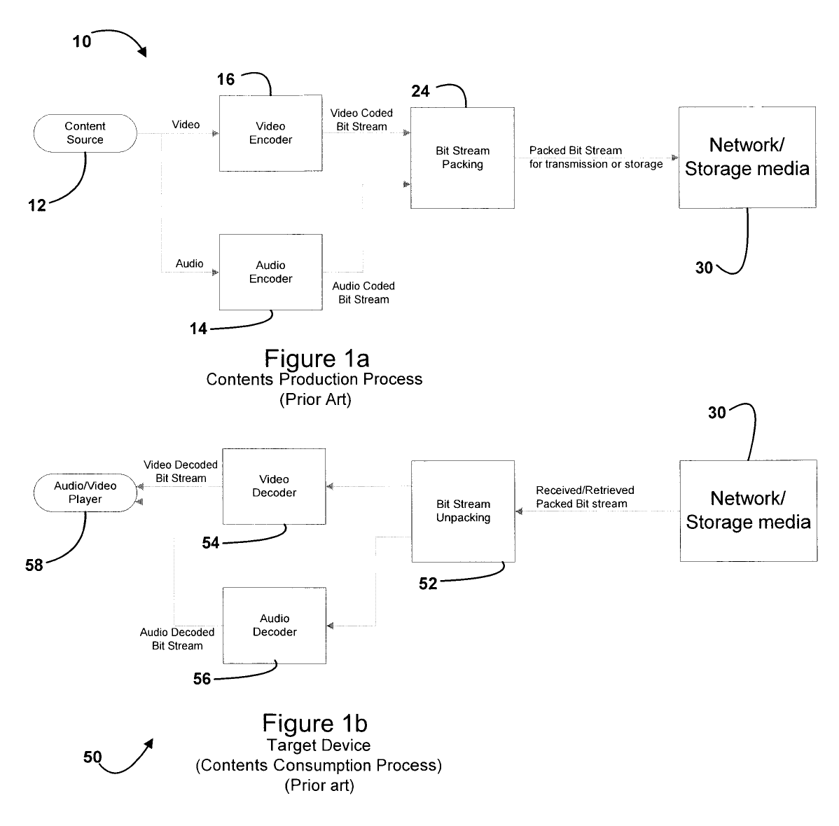

### DETAILED DESCRIPTION OF THE PREFERRED EMBODIMENTS

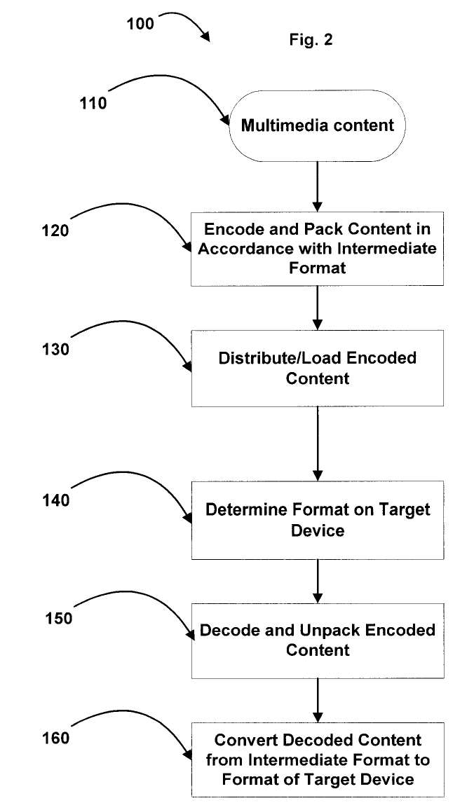

As described above, encoding multimedia content, such as audio, image, and video files, for distribution into a packed bit stream for each available format requirement can take a toll on resources such as storage space and bandwidth. One process 100 to address this issue is shown in FIG. 2. In the process 100, multimedia content 110 is encoded and packed into a bit stream in accordance with an intermediate format, as will be described in more detail below (action block 120). The packed bit stream is then distributed, e.g., loaded onto storage media, and/or loaded and/or broadcasted onto a target device having a playback system for playback (action block 130). The format requirements for the playback system of the target device (not shown) are determined, e.g., screen size and color depth (action block 140). The packed bit stream is then unpacked and decoded (action block 150). The unpacked and decoded multimedia content is then converted from the intermediate format to the format of the playback system of the target device (action block 160) on the fly. With this approach, only a single packed bit stream, or a reduced number of packed bit streams, is needed to support a number of format requirements, which desirably reduces storage space and/or bandwidth requirements and further reduces the effort needed in creating one packed bit stream for each playback format.

As mentioned above, preferably, content 110 is distributed with only one intermediate frame size. However, there could be a need for more than one intermediate frame size. In this case the content 110 can be distributed with one copy of the content 110 for each intermediate frame size on the distribution media. Alternatively, one intermediate frame size can be designated to each playback environment. In this case, only one copy of the content 110 is loaded on the distribution media for each playback environment.

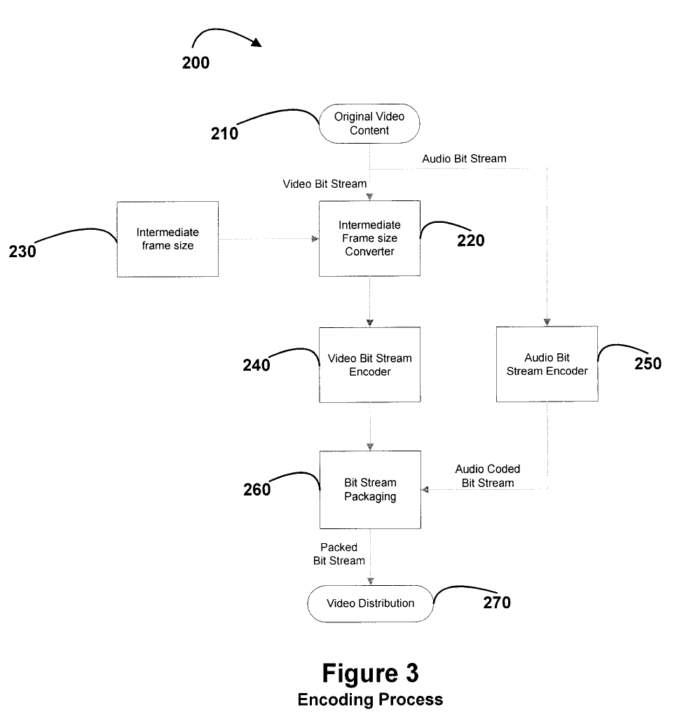

Turning to FIG. 3, an encoding system 200 for video content in accordance with the content and distribution process 100 is shown. The original video contents 210 are first scaled to a pre-defined intermediate size with an Intermediate Frame-size Converter 220 that receives an intermediate frame size 230. Often original movie content has much larger screen sizes, such as 1080i (1920×1080) or 720p (1280×720). Thus, the Converter often scales the content down; however, if the original multimedia content 210 is smaller than the intermediate size, then the content is scaled up. The converted video bit stream is then encoded with the Video Bit Stream Encoder 240 known in the art (any encoding system and/or Digital Rights Management (“DRM”) scheme can be used) and packed with an Audio Coded Bit Stream (generated by the Audio Bit Encoder 250 that receives the audio bit stream from the multimedia content 210) known in the art into the Packed Bit Stream via a bit stream packager 260 known in the art. The encoded and packed contents 270 are then distributed in the intermediate size 230. As one of ordinary skill in the art will appreciate, the encoding system 200 can be implemented as software residing on a computer readable medium for execution by a processing system or implemented as an integrated circuit. The system 200 can be integrated with a system for the generating and/or distributing multimedia content, for example, Verizon's V-Cast system, or the system 200 can be a separate component.

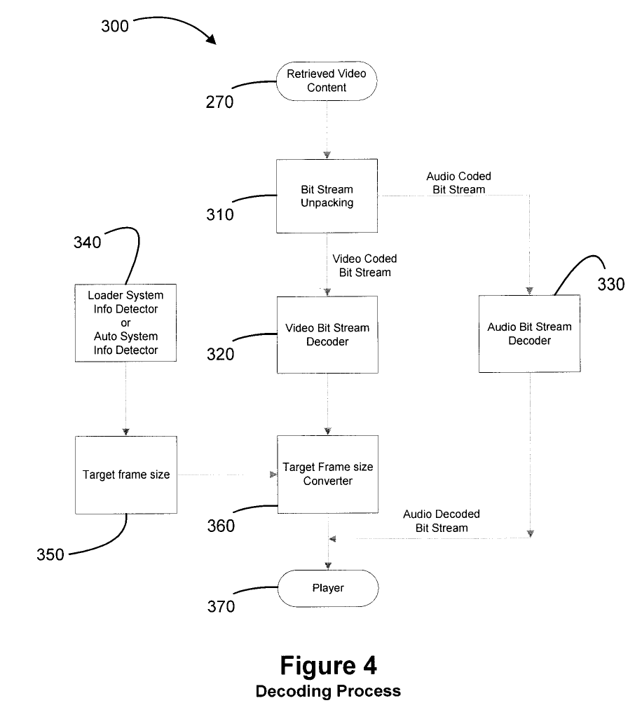

When the target device retrieves the video content, it unpacks and separates the Video Coded Bit Stream from the Audio Coded Bit Stream. Turning to FIG. 4, a system 300 for unpacking and decoding the multimedia content 270 is shown. The system 300 is coupled with the target device and can be implemented as software on computer readable medium to be executed by a processing system or can be implemented as an integrated circuit. The system 300 can be a stand alone device or a device integrated with the target device. Further, a single system 300 can support multiple playback systems and the system 300 can also be integrated with a playback system. The content 270 is first unpacked 310 and the Audio and Video Coded Bit Streams are separated. The Audio Coded Bit Stream is decoded with the Audio Bit Stream Decoder 330 and sent to the Player 370 for playback. The Video Coded Bit Stream is first decoded with the Video Bit Stream decoder 320 and then is converted from the intermediate frame size 230 to the target frame size 350 with the Target Frame-size Converter 360 on the fly. The target frame size 350 is provided by a frame size detection system 340 as will be described in more detail below. The converted video bit stream is also sent to the Player 370 for playback.

The converter 360 can be coupled to the output of the video bit stream decoder 320 as shown in FIG. 4. In the alternative, the function of the converter 360 can be integrated with the decoder 320, i.e., the video bit stream can be converted from the intermediate frame size 230 to the target frame size 350 during the video decoding process. With this alternative, part of the video stream decoding process can be eliminated for portions of corresponding video bit stream that are not needed for playback. For instance, for original video content in widescreen format and for target devices having a playback system that does not support widescreen format, in order to display the center part of the video in maximum size within the playback system, left and right portions of the video frame are cropped. With an integrated converter 360, the cropped portions can be determined before the decoding process, and thus, the decoding process can be bypassed for those cropped portions. As a result, the overall decoding performance may be improved, as one of ordinary skill in the art can appreciate.

Further, the function of the Target Frame-Size Converter 360, which is independent from the decoder 320 function, can be integrated with the multimedia content playback system instead of the decoder 320. Thus, any codec system that can coupled with the converter 360 and the playback system. The video decoded bit stream is converted from the intermediate frame size 230 to the target frame size 350 by the Target Frame-size Converter 360 during the playback process. The advantage of this approach is that it is codec independent.

The target frame size can be detected by the detection system 340 by the following method. When storage media, such as a flash card, having the multimedia content 270 is inserted or wirelessly transmitted or broadcasted content 270 is received, a content loader (not shown), known in the art, will detect the type of the target device and its model number and corresponding system information, which may include the CPU type, the system speed, the memory size, and format requirements such as the frame size of the playback system. The system information will be passed from the loader to the Target Frame-size Converter 360 for the intermediate frame-to-target frame converter. In an alternative method, the system information detection capability can be incorporated into the decoding process 400. With this approach, the target frame size 350 can be detected during the decoding process 400 automatically. A description of a content loader can be found in U.S. patent application Ser. No. 10/377,093, filed Feb. 27, 2003, to Mr. Johnathan P. Tann et al., entitled “Universal Loader for Portable Electronic Devices,” which is hereby incorporated by reference in its entirety.

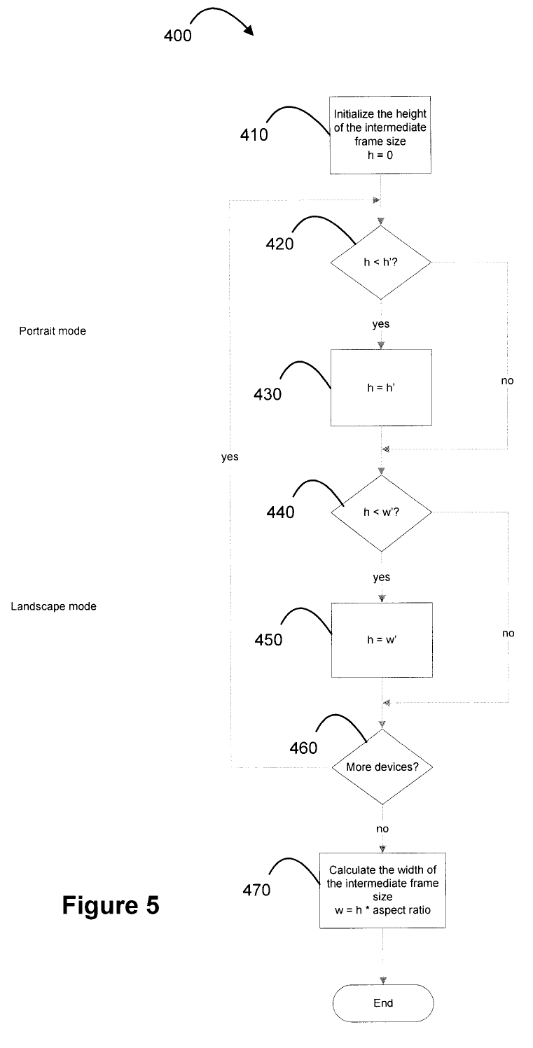

Turning to FIG. 5, a process 400 for selecting the intermediate frame size 230 is shown, which can be implemented as part of the encoding and packing system 200 on computer readable medium. The intermediate frame size 230 defined in accordance with this process 400 is based on the following guidelines:

In order to minimize the distribution storage space or the distribution transmission bandwidth, the intermediate frame size 230 should be kept as small as possible.

The intermediate frame size 230 should be large enough to retain the image quality.

The intermediate frame size 230 is chosen such that it can be easily converted to any target frame size.

Consider the Landscape Mode and the Portrait Mode, which are known in the art, as two separate playback environments for each target device.

Retain the aspect ratio of the original content.

In light of these guidelines, the process 400 is described as follows. The intermediate frame size is defined by its height, h, and width, w. The process 400 starts with a default height, h, at zero (action block 410). Then, for each target device, the following steps take place. The height, h, is compared to the height of the frame size of the format requirements for the playback system of a target device, h′ (comparison block 420). If less than the target device height, h′, the intermediate frame size 230, h, is set to the target device height, h′ (action block 430). This is a comparison performed for the portrait playback environment. The intermediate frame size 230, h, is then compared to target device width, w′ (comparison block 440). If less than the target device width, w′, then the intermediate frame size 230 height is set at target device width, w′ (action block 450). This is a comparison performed for the landscape playback environment.

Because support for multiple format requirements, e.g., multiple frame sizes, is contemplated, the portrait and landscape comparison processes described above are repeated for each contemplated frame size (comparison block 460). Subsequently, the width, w, of the intermediate frame size 230 is calculated as the product of the selected height, h, and the aspect ratio of the original multimedia content (action block 470).

For the Target Frame Size Converter 360, one or a combination of the following techniques can be used for adjusting the frame size in the Target Frame-size Converter 360:
Cropping horizontally—left, right, or both.
Cropping vertically—top, bottom, or both.
Stretching horizontally—left, right, or both.
Stretching vertically—top, bottom, or both.
Scaling up
Scaling down.

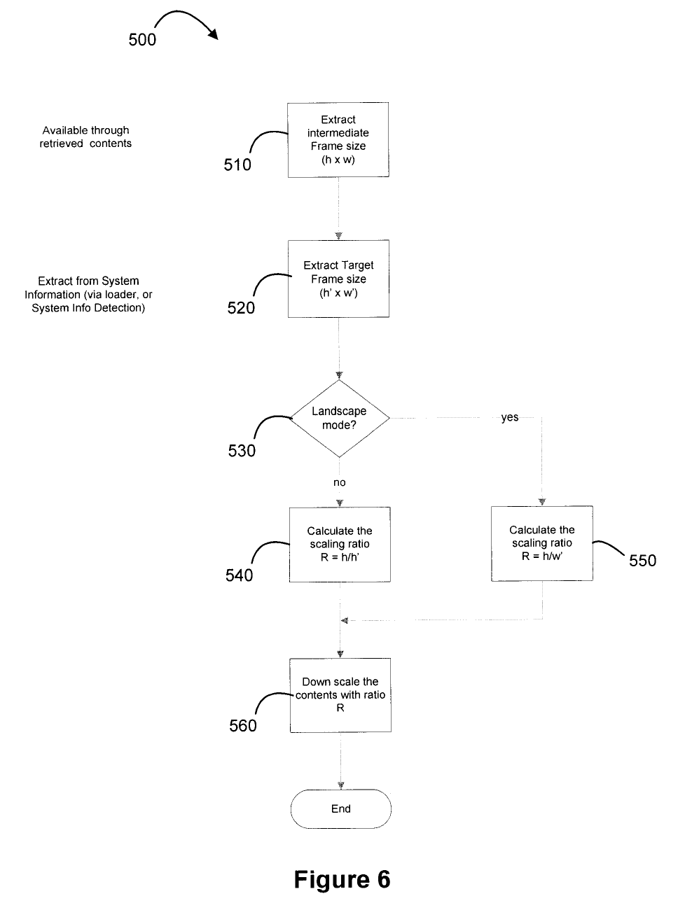

These techniques can be used in accordance with the following principles: (1) follow the user's choice of frame size, such as the landscape mode or the portrait mode, for playback; (2) retain the original contents aspect ratio if possible; and (3) position the video content to the center of the screen—both vertically and horizontally. Turning to FIG. 6, the operation 500 of a Target Frame Size Converter 360 is shown. In this embodiment, the playback system shows the full image of the video content at the largest possible size on the playback screen. The converter 360 first extracts the intermediate frame size 230, h×w (action block 510). This data is available from the received multimedia content 270 with techniques known in the art. The target frame size 350, h′×w′, is then extracted using methods described above (action block 520). The converter 360 then determines whether the content 270 is to be played in landscape mode (decision block 530). If so, then the scaling ratio R is calculated as the intermediate frame size 230 height, h, divided by the target frame size 350 width, w′ (action block 550). If not, then the scaling ratio R is calculated as the intermediate frame size 230 height, h, divided by the target frame size 350 height, h′ (action block 540). The unpacked and decoded video content is then scaled to the ratio R using techniques known in the art (action block 560).

Although the distribution and playback system 100 described above is described for the use of video content, the system 100 can be applied to any kind of multimedia content, such as video files described above, video games, and television broadcasting for cell phones, such as DVB-H, audio files and image files known in the art. Further, the system 100 can be applied to any kind of format requirement, including format size, resolution, and for video and audio content, samplings per second. For example, for video content, target devices may only be able to support a certain number of frames per second. Accordingly, the content can be distributed using a intermediary frames per second, e.g., thirty (30) frames per second. In this case, the system 100 can convert/scale the video content from thirty (30) frames per second down to twelve (12) frames per second to support the desired target devices. This same sampling conversion technique can be applied to audio as well as video content.

The system 100 can also be applied to the distribution and display of image files. For instance, the system 100 can be implemented as a mode of operation for a camera, such that when selected, will automatically store the raw image data into the selected intermediate format for distribution.

Although particular embodiments of the present inventions have been shown and described, it will be understood that it is not intended to limit the present inventions to the preferred embodiments, and it will be obvious to those skilled in the art that various changes and modifications may be made without departing from the spirit and scope of the present inventions. Thus, the present inventions are intended to cover alternatives, modifications, and equivalents, which may be included within the spirit and scope of the present inventions as defined by the claims.

What is claimed is:

1. A method for distributing multimedia content to a playback system, comprising:
converting the multimedia content into an intermediate format;
loading the converted multimedia content into the playback system; and
converting the multimedia content from the intermediate format to a format supported by the playback system, wherein the intermediate format and the format supported by the playback system are different.

2. The method of claim 1, further comprising encoding the multimedia content before loading the multimedia content into the playback system.

3. The method of claim 1, wherein format includes screen size.

4. The method of claim 1, wherein the multimedia content is one or more of a video file, audio file, graphics, and animation file.

5. The method of claim 4, wherein the format includes one or more of sampling rate and frame rate and resolution.

6. The method of claim 1, wherein the playback system is a video playback device on a cell phone, personal digital assistant, or portable multimedia player.

7. The method of claim 1, wherein the step of loading the converted multimedia content into the playback system includes broadcasting the multimedia content to the playback system from a central file server.

8. The method of claim 1, wherein the step of loading the converted multimedia content into the playback system includes transmitting the multimedia content to the playback system from a central network file server.

9. The method of claim 1, wherein the transmission is a wired or wireless transmission.

10. The method of claim 1, wherein the step of loading the converted multimedia content into the playback system includes inserting a portable memory device having the multimedia content into a computing device having the playback system.

11. The method of claim 1, wherein the portable memory device is a flash memory card, DVD, CD, Read Only Memory card, microdrive or minidisc.

12. The method of claim 1, wherein the multimedia content is a digital photograph.

13. The method of claim 1, further comprising the step of detecting the format supported by the playback system.

14. A system for distributing multimedia content to a playback system, comprising:
a multimedia content generator having a first converting device that converts original formatting of the multimedia content to an intermediate format;
a distribution medium configured to receive the converted content from the multimedia content generator having a loader for loading the converted content onto a storage medium coupled to the playback system; and
a second converting device coupled to the playback system that converts the multimedia content in intermediate format to a format supported by the playback system.

15. The system of claim 14, wherein the distribution medium is a network, wireless network, broadcast network, or communication bus.

16. The system of claim 14, wherein the playback system is a video playback device on a cell phone, personal digital assistant, or portable multimedia player.

17. The system of claim 14, wherein format includes screen size.

18. The system of claim 14, wherein the multimedia content is one or more of a video file, audio file, graphics, and animation file.

19. The system of claim 18, wherein the format includes one or more of sampling rate and frame rate and resolution.

20. The system of claim 14, wherein the second converting device is integrated with the playback system.

21. The system of claim 14, wherein the multimedia content is a digital photograph.

22. The system of claim 14, wherein the second converting device includes a detector configured to detect the format supported by the playback system.

23. The system of claim 14, wherein the system supports a Digital Rights Management System.

24. A multimedia playback system, comprising:
a multimedia player supporting a multimedia format;
a converting device coupled to the multimedia player configured for receiving multimedia content in an intermediate format and converting the multimedia content from the intermediate format to the multimedia format supported by the multimedia player.

25. The system of claim 24, wherein the converting device is configured to receive the multimedia content from a network, wireless network, broadcast network, or communication bus.

26. The system of claim 24, wherein the multimedia player is a digital video player on a cell phone, personal digital assistant, or portable multimedia player.

27. The system of claim 24, wherein format includes screen size.

28. The system of claim 24, wherein the multimedia content is one or more of a video file, audio file, graphics, and animation file.

29. The system of claim 28, wherein the format includes one or more of sampling rate and frame rate and resolution.

30. The system of claim 24, wherein the converting device is integrated with the multimedia player.

31. The system of claim 24, wherein the multimedia content is a digital photograph.

32. The system of claim 24, wherein the converting device includes a detector configured to detect the multimedia format supported by the multimedia player.

33. The system of claim 24, wherein the system supports a Digital Rights Management System.
